(19) United States
(12) Patent Application Publication
(10) Pub. No.: US 2005/0254370 A1
(43) Pub. Date: Nov. 17, 2005

(54) Mass storage using modern compact disk

(76) Inventor: Charles Ryan Hedensten, Longmont, CO (US)

Correspondence Address: BARBER LEGAL, P.O. BOX 16220, GOLDEN, CO, 80402-6004, US

(21) Appl. No.: 11/125,762

(22) Filed: May 10, 2005

Related U.S. Application Data
(60) Provisional application No. 60/569,925, filed on May 12, 2004.

(51) Int. Cl. G11B 5/09

(52) U.S. Cl. 369/47.1; 369/53.1

(57) ABSTRACT

A mass storage device using an optical disk such as a compact disk, DVD-RW, BLU-RAY disk or the like to mimic to the operating system and BIOS of a electronic device the operations of a traditional magnetic fixed media device (hard drive). The invention teaches that an optical disk may be provided with sectors and tracks, a sealed case, a boot sector, “hard disk” information to provide to the BIOS and OS, track access control of servomechanisms, a repeatable run-out error constant, and other “hard drive” features. An OS interface module mimics to the OS the operations of the hard drive while an interface to optical disk control translates between the hard drive type commands and the actual optical disk controls. Optical disk controller and subcomponents and the disk itself may be modified from usual optical disk layout and mechanisms to better mimic fixed magnetic media operations.

### CROSS-REFERENCE TO RELATED APPLICATIONS

This application claims the priority and benefit of U.S. Application No. 60/569,925 filed May 12, 2004 in the name of the same inventor, Charles R. Hedensten and with the same title, the entire disclosure of which is incorporated herein by this reference thereto.

### FIELD OF THE INVENTION

This invention relates generally to electronic devices and specifically to mass storage devices having features of both magnetic and optical media.

### STATEMENT REGARDING FEDERALLY FUNDED RESEARCH

This invention was not made under contract with an agency of the US Government, nor by any agency of the US Government.

### BACKGROUND OF THE INVENTION

Mass storage of digital information is normally carried out in a variety of physical media having different characteristics in terms of optimal use and interface with the operating system.

One common form of media is the magnetic disk. A substrate carries thereon a thin magnetic media, a magnetic head addresses the media by sector and track. The ubiquitous hard drive is the foremost example of this. The sealed disks, heads and drive mechanisms are installed in an electronic device such as a computer, telephone, refrigerator, camera or the like in an essentially permanent form normally requiring actual internal work to remove. Due to the sealed nature of the drive, a high degree of reliability and a high degree of data density may both be achieved. An older form, the floppy drive, also uses magnetic media, but being essentially unsealed, the capacity dwindles dramatically: normally the technology of floppy technology offers an order of magnitude less storage capacity than a sealed drive unit. Standardization considerations normally widen this gap to several orders of magnitude. For example a “standard” 3.5 inch floppy disk may be used to store roughly 1.44 megabytes of information (less standard “standards” offer the technical capability to store more), while a fairly typical sealed electronic device hard drive as of early 2004 may easily store 160 gigabytes of information: a five order of magnitude difference. This difference may be considered to be largely due to the differences between removable and fixed media.

In the area of removable media, optical disks offer considerably greater storage capacity. The “standard” CD-ROM type optical disk offers roughly ½ gigabyte of storage capability which may be removed from the electronic device or computer and taken to a different machine. The optical technology is considerably different from the magnetic technology: a laser is used to burn small “bumps” or “pits” into the optical media. The traditional disk organization is in the form of a spiral track on the surface of the media, due to the fact that the device was originally conceived largely for “Read Only” purposes such as music playback. The cost of such devices is considerably lower than that for hard drives: roughly $30USD in early 2004 compared to the roughly $150USD cost of a typical hard drive.

Newer types of optical disk may store a considerable quantity of information. For example, the “BLU-RAY” type device is presently of high cost but offers the potential for 100 GB of storage capacity using wobble burns and other techniques. Such removable media present new opportunities to hardware engineers, software engineers, and users. Removable optical media on the market offer up to 30 GB per diskette.

The use of compact disk or optical disk devices comes with certain inherent limitations, however, relating to certain commonly available operating systems used with small electronic devices such as computers and telephones. In general, optical disks require different access commands and data structures than hard disks. However, present day operating systems co-evolved with hard disk technology. Thus accessing hard disks through most operating systems is a much simpler and more direct operation than accessing an optical disk. For example, operating systems (for example Windows CE, a trademark of the Microsoft Corporation) for devices such as telephone operating systems, PDA operating systems, computer operating systems are customarily stored upon hard drives in what is called a “boot sector”, an item lacking in a properly formatted optical disk. Direct copying to a hard drive is a one step operation to most users of hard drives, but a two step operation involving the invocation of special software such as the “ROXIO” CD Writer/Creator software and the like.

In the past, efforts to combine certain features of hard drive and optical drive technology have had mixed success. Optical guiding of magnetic floppy drive heads (Magneto-Optical or “MO” drives) resulted in floppies having the ability to store 10 MB or more of information, but never became standard. Other efforts include removable sealed hard drives and the like. Certain removable optical media are known which use a type of sectorial addressing to provide a very small removable optical storage device for MPEG files, useful in such applications as video cameras.

It would be preferable to provide a device having favorable features of an optical disk drive, yet be accessible to the operating system in the same manner as a hard drive, and be able to support operations of an operating system.

It would also be preferable to provide an optical disk having an arm type actuator rather than a servo-controlled head on a screw slide.

### SUMMARY OF THE INVENTION

General Summary

The present invention teaches an optical disk and optical disk controller such as a compact disk, DVD-RW, BLU-RAY disk or the like to mimic to the operating system and BIOS of a computer or other type of electronic device the operations of a traditional magnetic fixed media device (hard drive) so as to provide mass data storage. The invention teaches that an optical disk may be provided with sectors and tracks, a sealed case, a boot sector, “hard disk” information to provide to the BIOS and OS, track access control of servomechanisms, a repeatable run-out error constant, and other “hard drive” features. An OS interface module mimics to the OS the operations of the hard drive while an interface to optical disk control translates between the hard drive type commands and the actual optical disk controls. Optical disk controller and subcomponents and the disk itself may be modified from usual optical disk layout and mechanisms to better mimic fixed magnetic media operations.

Summary in Reference to Claims

It is therefore a first aspect, advantage, objective, and embodiment to provide a mass storage device for use with an electronic device, computer peripheral, or computer having an operating system, the mass storage device comprising: a hard disk to operating system interface module operatively connected to such operating system and capable of interacting with such operating system as a hard drive by receiving hard drive specific commands from such operating system and by sending to such operating system hard drive specific information; an interface to disk control module operatively connected to the hard disk to operating system module; a compact disk controller operating the hardware of a sealed compact optical disk and operatively connected to the interface to disk control module; the interface to disk control module capable of using hard drive specific commands received by the hard disk to operating system interface module to command the compact disk controller, and further capable of receiving information from the compact disk controller and providing therefrom hard drive specific information.

It is therefore a second aspect, objective, embodiment and advantage of the present invention to provide an improved electronic device such as a computer, information device, communication device, home appliance, small appliance, tool or the like, which electronic device has an operating system, wherein the improvement comprises: an optical mass storage device having thereon a boot sector, the optical mass storage device being addressable by such operating system as a hard drive.

It is therefore another aspect, objective, embodiment and advantage of the present invention to provide an improved electronic device having an operating system, wherein the improvement comprises:
an optical mass storage device having thereon a boot sector, the optical mass storage device being addressable by such operating system as a bootable drive.

It is therefore another aspect, objective, embodiment and advantage of the present invention to provide an improved electronic device wherein the optical mass storage device addressable by such operating system is further addressable as a hard drive.

It is therefore another aspect, objective, embodiment and advantage of the present invention to provide an improved electronic device wherein the optical mass storage device is sealed.

It is therefore another aspect, objective, embodiment and advantage of the present invention to provide an improved electronic device wherein the optical mass storage device is formatted so as to be randomly accessible.

It is therefore another aspect, objective, embodiment and advantage of the present invention to provide an improved electronic device wherein the optical mass storage device is addressed by sector and track.

It is therefore another aspect, objective, embodiment and advantage of the present invention to provide an improved electronic device wherein the optical mass storage device is fixedly mounted in the electronic device.

It is therefore another aspect, objective, embodiment and advantage of the present invention to provide an improved electronic device wherein the improved electronic device further comprises one member selected from the group consisting of: information devices, communication devices, computer peripherals, games, appliances, tools, telephones, personal digital assistants, cameras, audio equipment, video equipment and combinations thereof.

It is therefore another aspect, objective, embodiment and advantage of the present invention to provide an improved electronic device wherein the improved electronic device further comprises a computer.

It is therefore another aspect, objective, embodiment and advantage of the present invention to provide an improved electronic device wherein the computer further comprises at least one standard electronic connector.

It is therefore another aspect, objective, embodiment and advantage of the present invention to provide an improved electronic device wherein the computer further comprises at least one standard peripheral.

It is therefore another aspect, objective, embodiment and advantage of the present invention to provide a mass storage device for use with a electronic device having an operating system, the mass storage device comprising:
a hard disk to operating system interface module operatively connected to such operating system and capable of interacting with such operating system as a hard drive by receiving hard drive specific commands from such operating system and by sending to such operating system hard drive specific information;
an interface to disk control module operatively connected to the hard disk to operating system module;
a compact disk controller operating the hardware of a sealed compact optical disk and operatively connected to the interface to disk control module;
the interface to disk control module capable of using hard drive specific commands received by the hard disk to operating system interface module to command the compact disk controller, and further capable of receiving information from the compact disk controller and providing therefrom hard drive specific information.

It is therefore yet another aspect, objective, embodiment and advantage of the present invention to provide a mass storage device wherein the sealed compact optical disk is formatted so as to be randomly accessible.

It is therefore yet another aspect, objective, embodiment and advantage of the present invention to provide a mass storage device wherein the sealed compact optical disk is addressed by sector and track.

It is therefore yet another aspect, objective, embodiment and advantage of the present invention to provide a mass storage device wherein the optical mass storage device is fixedly mounted in the electronic device.

It is therefore yet another aspect, objective, embodiment and advantage of the present invention to provide a mass storage device wherein such electronic device having an operating system further comprises one member selected from the group consisting of: computers, information devices, communication devices, computer peripherals, games, appliances, tools, telephones, personal digital assistants, cameras, audio equipment, video equipment and combinations thereof.

It is therefore yet another aspect, objective, embodiment and advantage of the present invention to provide a mass storage device further comprising:
a plurality of actuator arms, each actuator arm having thereon at least one read/write head, the actuator arms located at different locations on the mass storage device.

It is therefore yet another aspect, objective, embodiment and advantage of the present invention to provide a mass storage device wherein at least two actuator arms are located on different sides of the mass storage device.

It is therefore yet another aspect, objective, embodiment and advantage of the present invention to provide a mass storage device wherein the interface to disk control module further comprises:
an analog to digital converter (A/D converter) capable of receiving analog format information and converting it to digital information.

### BRIEF DESCRIPTION OF THE DRAWINGS

FIG. 1 is a PRIOR ART planform view representing a compact disk writing format.

FIG. 2 is a planform view representing an optical disk written according to the present invention.

FIG. 3 is a planform view representing an optical disk drive according to the present invention.

FIG. 4 is a rear view of an optical disk drive according to the present invention.

FIG. 5 is a block diagram of the invention.

FIG. 6 is a planform view representing an optical disk drive according to a second embodiment of the present invention.

FIG. 6a is a end view of representing an optical disk drive according to a second embodiment of the present invention.

FIG. 7 is a first side view of a third embodiment of the present invention, in which the device is incorporated into a portable non-self-contained computer system

FIG. 8 is a front view of the third embodiment of the present invention.

FIG. 9 is a second side view of the third computer system embodiment of the invention.

FIG. 10 is a top view of a fourth self-contained portable computer embodiment of the invention, unfolded in the use configuration.

FIG. 11 is a planform internal block view of the fourth embodiment showing a general configuration of the internal devices.

FIG. 12 is a side view of the fourth embodiment of the invention, folded.

FIG. 13 is a rear view of the fourth embodiment.

FIG. 14 is a partially transparent front view of a fifth embodiment.

FIG. 15 is a block diagram of a sixth embodiment.

### INDEX OF REFERENCE NUMERALS

Compact disk 50
Central hole 52
Periphery 56
Representation of writing track 60
Disk of invention 100
Central hole 102
Inner track 104
Outer track 106
Boot sector 108
Diskdrive 120
Case 122
Head race 124
Laser diode 126
Clamp 128
Read/write head 130
Axis 132
IEEE interface 140
Fiber optic interface 142
Power plug receptacle 144
Data interface 146
Optical disk drive 150
Optical disk 152
Motors, servos mechanisms 154
Optical disk control module 156
Interface to disk control module 158
HD to operating system interface module 160
Operating system 162
Disk drive 220
Case 222
Laser diode 226
Clamp 228
Read/write head 230
Axis 232
First data interface 240
First power interface 244
First side view 300
Case 302
USB ports 304
Mouse/keyboard port 308
Front side view 400
Case 406
Second side view 500
Case 502
LAN port 508
Power switch 506
Computer 600
Power switch 602
Lower half of clamshell body 606
Keyboard 614
LED indicator 618
Screen 620
Upper half of clamshell body 624
Disk 700
Computer 720
Lower half of clamshell body 722
Head race 724
Laser diode 726
Jacks 728
Read/write head 730
Axis 732
Power port 734
Flex-lead connector to screen 738
Connector ports 742
Expansion bay 748
Motherboard 764
Battery 770
Upper half of clamshell body 780
Bottom side 782
Computer, folded 820
Case 822
Power port 824
Connectors 826
Fan 828
Electronic device 900
Operating system 902
Disk drive 904
Computer 1000
Information device 1002
Communication device 1004
Tool 1006
Audio equipment 1008
Video equipment 1010
Camera 1012
Telephone/audio player 1014
PDA 1016
Game 1018
Computer peripheral 1020
Computer peripheral 1022
Appliance 1024

### DETAILED DESCRIPTION

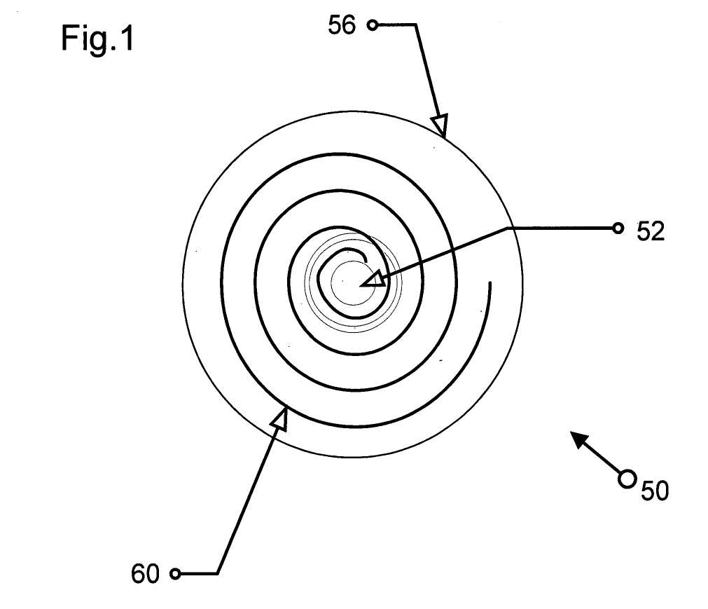

FIG. 1 is a PRIOR ART planform view representing a compact disk writing format. It will be appreciated that compact disk 50 has central hole 52, periphery 56 and a representation of a writing track 60. In use, disk 50 is placed into an unsealed CD drive and central hole 52 is used as an axis and to drive the disk to the required rotation speeds. In a typical prior art CD drive, these speeds may be as low as 200 to 500 RPM.

Writing track 60 is an extremely exaggerated and crude representation of the fact that a traditional CD disk, being originally designed for a write once and read only application such as music or video playback, is not laid out for maximum random access efficiency. In fact, write track 60 represents an extremely long spiral which contains a single large file (such as a single song) on a compact optical disk. More modern file formats such as MPG, .MP3 and the like to not alter this arrangement. More modern disk writing methods such as DVD format also do not alter this fundamental fact.

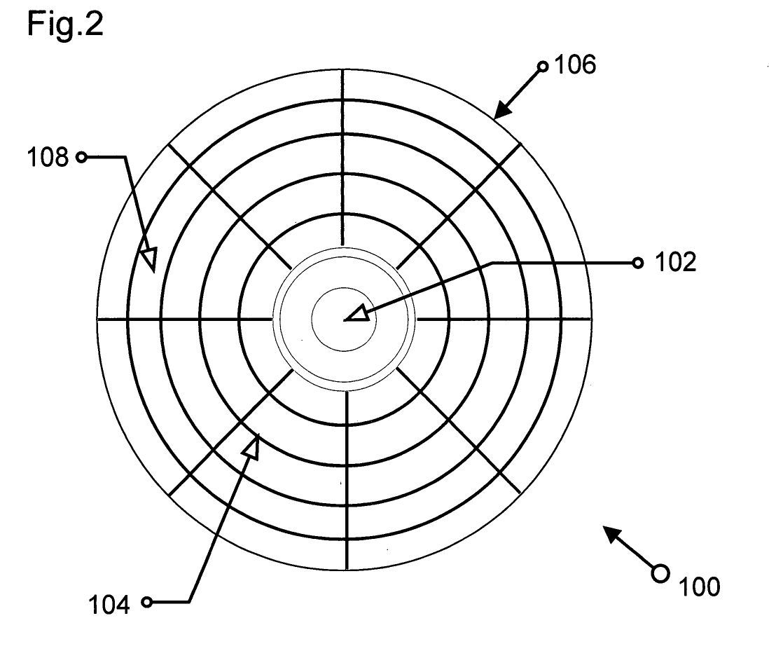

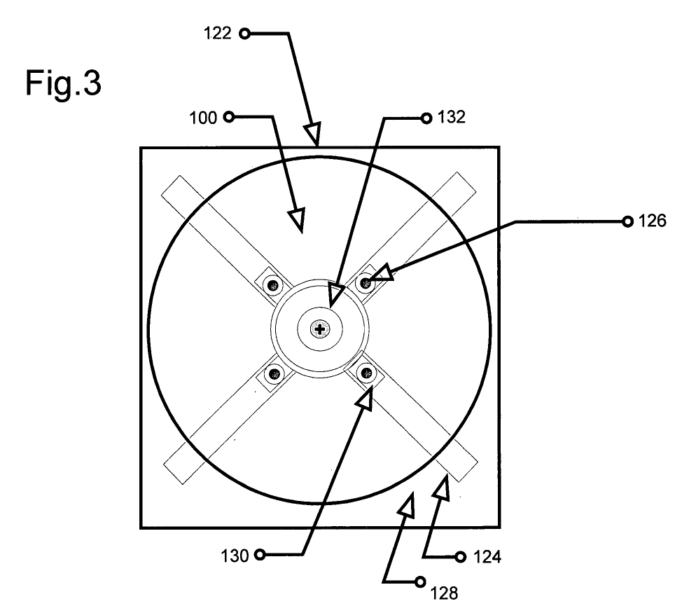

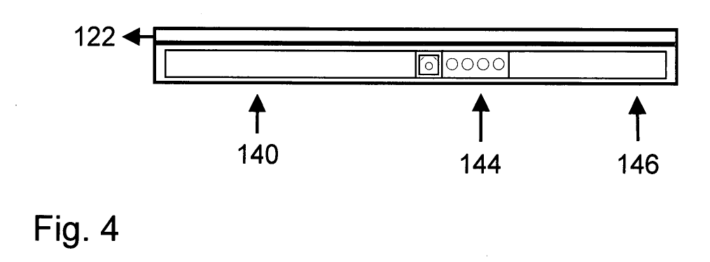

FIG. 2 is a planform view representing an optical disk written according to the present invention. FIG. 3 is a planform view representing an optical disk drive according to the present invention. FIG. 4 is a rear view of an optical disk drive according to the present invention. Disk of invention 100 has central hole 102 which may be the same size as traditional central holes, but need not be, due to the fact that unlike prior art optical disks, disk 100 will not be transferred from one drive to another. This allows the making of custom media (disk 100) in dimensions and configurations which are not standardized, so long as the control mechanisms discussed herein are able to compensate for the potentially unique layout of a disk according to the invention.

In one presently preferred embodiment, and the best mode now contemplated, inner track 104 and outer track 106 are laid out more like a hard drive disk media than like a traditional optical disk layout according to the prior art. Thus, the optical disk of the invention may have boot sector 108 which will support the operation of an operating system in much the same manner as the boot sector of a magnetic hard drive would: this sector will be addressed at device boot up, if booting from the invention is indicated by the BIOS of the device/computer/appliance/telephone/tool/game/combination thereof.

Disk drive 120 shows disk 100 within supporting hardware. Case 122 may be sealed in the best modes now contemplated and the preferred embodiments. It may be shock resistant, much like a magnetic hard drive. Case 122 may include a base deck, top cover, and may have within it such standard hardware as a PCB control board, motor, servomechanisms, screw-slides, and the like.

Head race 124 allows laser diode 126 (one of multiple possible lasers in the preferred embodiment) to move radially in and out across the entire width of the write/read surface of the disk. Read/write head 130 carrying laser diode 126 and may be servo actuated. Screw servos provide an accurate and inexpensive structure capable of precise radial motion. In preferred embodiments, several servos and heads may be used. In alternative embodiments, an actuator arm device used in most magnetic media may be employed: such devices are arms which swivel at the base while the tip carries a read/write head. In yet other alternative embodiments, the device may use more than a single actuator arm and thus multiple read/write heads. In various embodiments, the actuators may be located above the actual optical disk, or below it, on both sides and so on. In addition, the actuators and heads may be located at one, some or all of the corners of a generally square drive while in other embodiments they may be located along sides of the drive, and in yet other embodiments in a combination of locations.

Various combinations of drive controllers/lasers/media may be used. One which is favored at the present time is BLU-RAY (trademark not associated with applicant) technology. This removable media standard uses wobble burns to achieve a single disk storage capacity of 27 GB in a single layer format, 50 GB in a double layer format, with a blue-violet diode at a wavelength of 450 nm.

Clamp 128 at axis 132 may be used to rotate the device. Note that since the securing of disk 100 to axis 132 is permanent, a considerably higher rotational speed may be obtained in later embodiments. More importantly, greater positional accuracy may be physically obtained, reducing the computational demand on the drive controller to maintain accurate read/write register. This also eliminates or makes constant certain types of register errors, for example, the difference in placement between putting a removable diskette exactly on center and the actual position attained by such removable media. As with magnetic media, a repeatable run-out error may be determined at the factory during manufacture, written into the device, and the disk controller may thereafter use that constant to simplify the mathematics of tracking. Use of such “fixed media” parameters is one typical structural difference between the invention and the prior art removable optical disk media. The importance of this may be understood in reference to the fact that (contrary to the representation in FIG. 2) a single write track may be 0.5 microns in width, with a mere 1.6 microns separating one track from the next.

Physical connection of the invention to the electronic device may be assured by several devices of the connector/port/jack type. An IEEE interface 140 such as IEEE 1394 or others may be used, or a fiber optic interface 142 may be used, or another data interface 146 such as a SCSI bus connection, an ATA standard adapter using ribbon connectors such as IDE/ATAPI, USB2, and so on through interfaces now known or later developed. Power plug receptacle 144 may be a standardized electrical power receptacle allowing an operative electrical power connection to a power supply at various voltages, including standard voltages like 5 volts, 12 volts, etc.

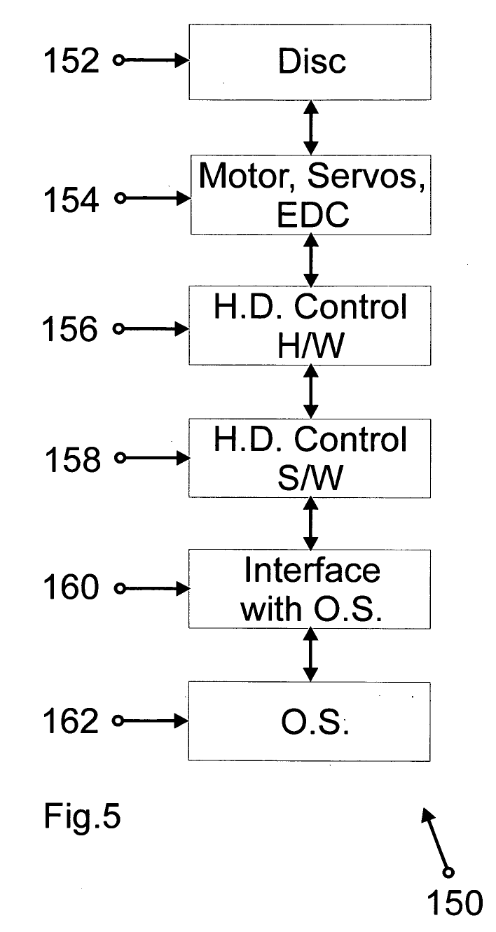

FIG. 5 is a block diagram of the invention. Optical disk drive 150 may be comprised of several overall modules. Optical disk 152 may be as discussed previously, although within the bounds of the final claims, it may vary from the specification parameters. Motors, servos mechanisms and other hardware (motors, PCB controller, etc) 154 are the various physical drive mechanisms necessary to physically operate the device. Electronic drive control 154 (“EDC”) thus physically controls the drive.

Optical disk control module 156 and interface to disk control module 158 may be modified in software or hardware devices to compensate for the differences between the device and prior art removable media. For example, hardware for insertion and removal of diskettes is un-necessary in the invention. On the other hand, the optical disk control module 156 may advantageously know and recognize a boot area of the disk. It may further use sector/track addressing of the physical media so as to provide true random access to data stored thereon. Yet another structural difference from prior art may be the provision of an A/D (analog/digital) converter for the data of the disk: the A/D converter may be provided on-board, a configuration not yet known in the industry. Such A/D converters receive analog information (such as audio file information) and convert it to digital information, thus allowing use of analog format files on disks. An on-board converter may provide easier connection to devices not having internal A/D converters of their own. Servo control chips may be modified to allow interface 158 to control the servo for track selection, rather than just requiring track following by the heads. In general, what is provided is an interface to disk control module operatively connected to the hard disk to operating system module; a compact disk controller operating the hardware of a sealed compact optical disk and operatively connected to the interface to disk control module; wherein the interface to disk control module is capable of using hard drive specific commands received by the hard disk to operating system interface module to command the compact disk controller, and is also further capable of receiving information from the compact disk controller and providing therefrom hard drive specific information. Examples of such information include providing to the BIOS information on the total number of tracks, sectors, and heads. Other information includes location of a landing zone for the heads, RPM and the like.

“Plug and Play” functionality may further be provided such that when the device is physically connected to the electronic device, the OS immediately recognizes it has a fixed media for mass storage in the same manner as a hard drive. Such information may be provided to OS makers, provided in other ways, provided by the disk controller, etc.

HD to operating system interface module 160 serves the function of mimicking the functions and results of a hard drive to the operating system 162. In order to minimize problems with operating systems, it is desirable if the physical drive of the invention mimics, at the device, BIOS and OS levels, the operation of a hard drive. For the invention, it is necessary to provide a hard disk to operating system interface module operatively connected to such operating system and capable of interacting with such operating system as a hard drive by receiving hard drive specific commands from such operating system and by sending to such operating system hard drive specific information. This difference from the prior art cannot be minimized in importance.

Firstly, this allows the device to act as a hard drive, even to the extent of having an operating system thereon and allowing boot of the electronic device therefrom.

Secondly, the device may further act as the mass storage device for the electronic device with read/write operations exactly like a hard disk as seen from the OS or application program viewpoint.

Thirdly, this allows elimination of the hard drive. This is a great economic advantage. A typical compact disk drive may be manufactured and even retailed for under $30.00USD, while out of the typically $500.00USD cost of a bottom end computer, the hard drive usually is a minimum of $150.00USD. The difference represents an enormous savings in manufacturing costs, steps, difficulty and labor. Similar savings may be achieved with set top boxes for cable/satellite TV (which devices now frequently incorporate hard drives), with electronic games, with personal digital assistants (PDAs), with appliances (which increasingly may have operating systems) and so on.

Fourthly, this allows the device to be prewritten at manufacture, with additional consequent cost and burden savings.

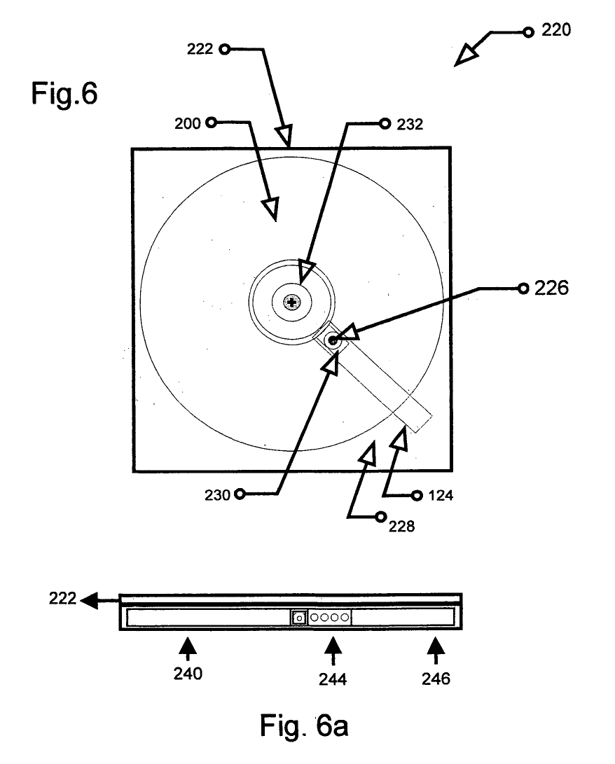

FIG. 6 is a planform view representing an optical disk drive according to a second embodiment of the present invention, FIG. 6a is a end view of representing an optical disk drive according to a second embodiment of the present invention. Disk drive 220, case 222, laser diode 226, clamp 228, read/write head 230, and axis 232, as well as first data interface 240 and first power interface 244 may be much as previously described. However, in this embodiment, a single laser head on a single actuator arm or servocontrolled head-in-track screw-slide may be used instead of multiple units.

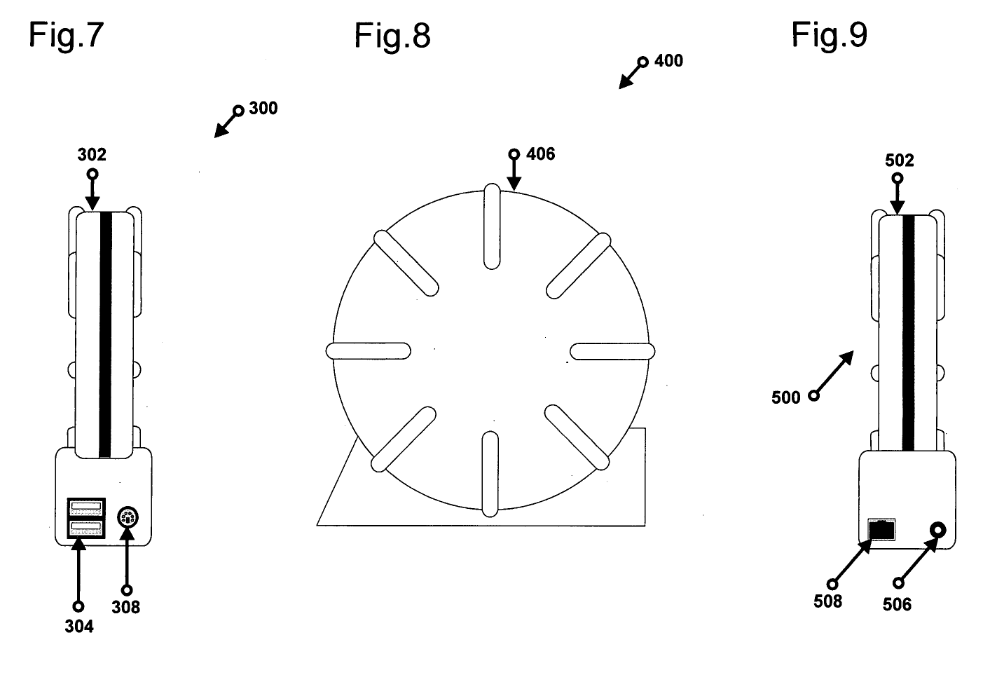

FIG. 7 is a first side view of a third embodiment of the present invention, in which the device is incorporated into a portable non-self-contained computer system FIG. 8 is a front view of the third embodiment of the present invention. FIG. 9 is a second side view of the third computer system embodiment of the invention.

In this embodiment of the invention, a portable computer is provided which is not much larger than the actual size of the mass storage device itself. The computer has standardized connectors allowing operative electronic connections to peripherals devices (not shown) such as keyboard, mouse, printer, monitor, docking cradles, modems, routers, hubs, servers, cameras, external drives, audio equipment, video equipment and all other types of standard computer peripheral now known or later devised. (As an example, a printer may connect to a computer via a parallel port, a USB port, a PS/2 port and so.) The computer is exceptionally portable since the user can simply carry the actual computer itself (shown in the Figures) to the location of another computer, then un-plug peripherals from the other computer and plug those peripherals into the computer of the invention.

The mass storage device of the invention is able to substitute for a hard drive, thus eliminating the need for a traditional magnetic hard drive. The drive of the invention may be provided with the boot capability of a hard drive and may additionally support all other OS procedures necessary to operation of the computer, as from the viewpoint of the OS, the device is a magnetic hard drive.

As noted previously, the mass storage device of the invention offers a cost advantage over traditional magnetic hard drives: an optical drive having a baseline cost of roughly $30USD may be substituted for a magnetic hard drive having a baseline cost of at least $150USD. This cost advantage in turn translates into a cost advantage for the computer as a whole. The removal of peripherals such as listed above allows additional cost reductions, until it becomes reasonable to provide to the end consumer a computer device having a cost below $200USD, 2004FYD. Obviously, the same savings carry over into the other types of electronic devices having operating systems, such as mixers, audio equipment, video equipment, telephones and the like.

First side view 300 shows case side 302 and ports 304, which may be USB ports as pictured, or other standardized ports such as IEEE 1394 or others. Mouse/keyboard port 308 may be a PS2 port or may be another type of peripheral port for the same or a different type of port.

Front side view 400 shows case front 406, while second side view 500 shows case second side 502 having a LAN, TCP/IP port or other port 508, and power switch 506.

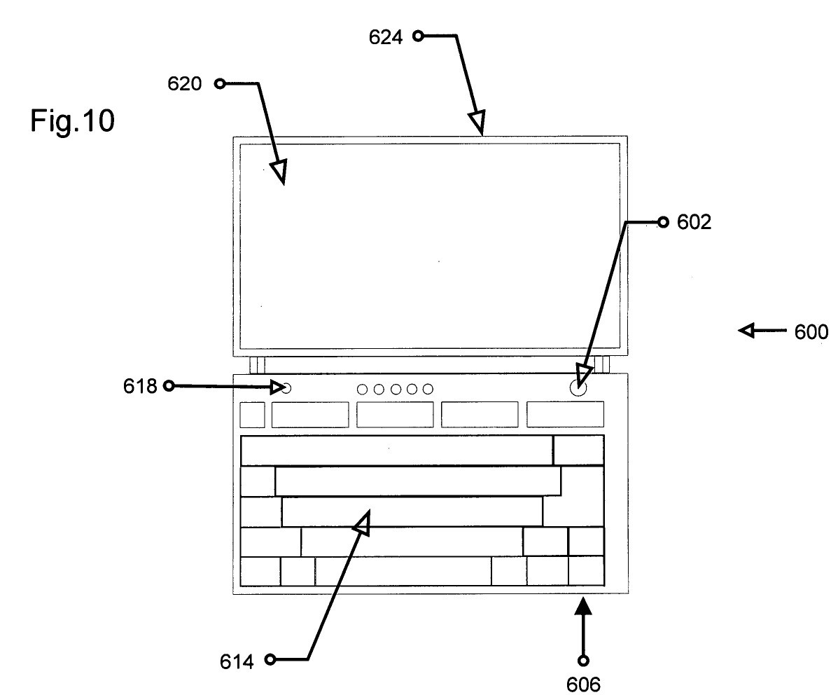

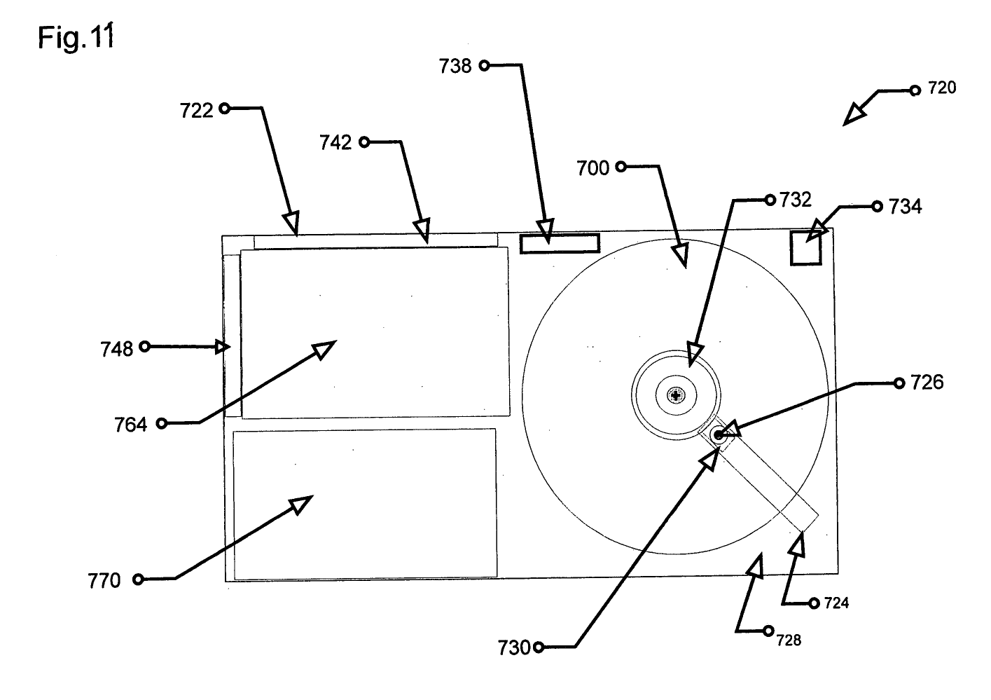

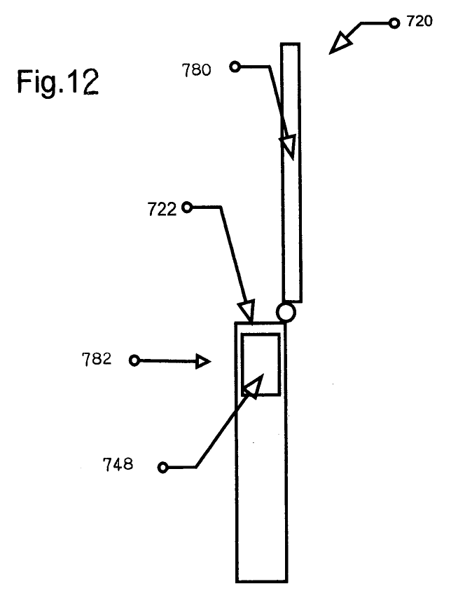

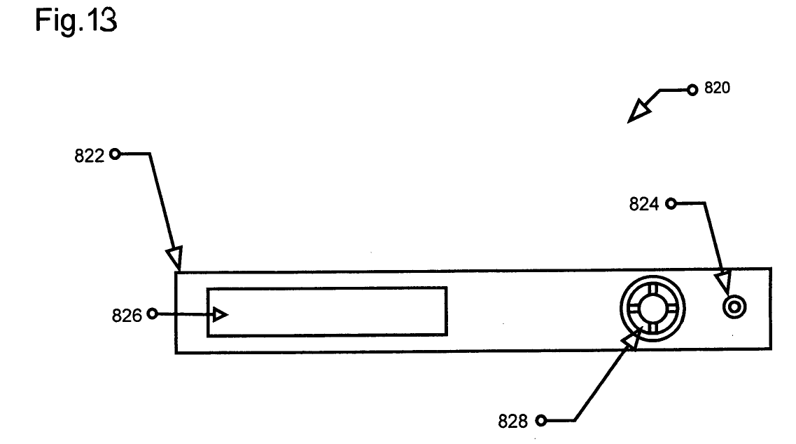

FIG. 10 is a top view of a fourth self-contained portable computer embodiment of the invention, unfolded in the use configuration. FIG. 11 is a planform internal block view of the fourth embodiment showing a general configuration of the internal devices. FIG. 12 is a side view of the fourth embodiment of the invention. FIG. 13 is a rear view of the fourth embodiment.

This embodiment may be more expensive due to having sufficient peripherals (screen, keyboard, etc) sufficient to allow independent usage. Computer 600 has power switch 602 on lower half of clamshell body 606, and has keyboard 614. LED indicator 618 may be one of a plurality indicating power, caps lock status, num lock status or other computer constraints.

Screen 620 may be an LCD screen, a gas plasma display, or other equivalent thin or flat display. Upper half of clamshell body 624 contains the screen and has a flexible connection to the lower half.

Disk 700 is internally located under the keyboard, computer 720 uses disk 700, though an optical disk, as the mass storage device and OS “home”, thus eliminating the cost, weight and expense of a hard drive. Lower half of clamshell body 722 also has head race 724 and laser diode 726, as well as jacks 728 and read/write head 730.

Disk 700 spins on axis 732.

Power port 734 may be used to supply power to the computer.

Flex-lead connector to screen 738 allows the clamshell halves to rotate in relation to one another. Connector ports 742 may be as discussed above or may be parallel, serial, or other legacy ports, or other ports know known or later developed.

Expansion bay 748 may provide a degree of expandability: it may be a proprietary bay or a PCMCIA slot type I, II, III or IV, or other equivalent device.

Motherboard 764 and battery 770 may be as known. Upper half of clamshell body 780 and bottom side 782 (shown in profile) are as known, folded together, the allow the computer to assume the folded configuration 820.

Case 822 seen from the rear shows power port 824, connectors 826, cooling fan 828 and other computer peripherals as needed.

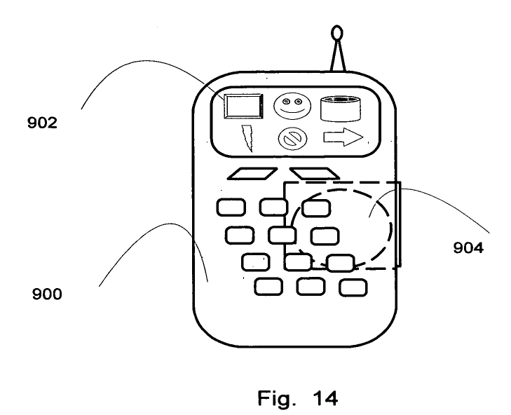

FIG. 14 is a front view, partially transparent, of a fifth embodiment. Electronic device 900 has an iconic visual operating system 902 which may be stored, with other data, upon a disk drive 904. At boot up of the electronic device 900, the disk drive 904 is accessed for the operating system 902. It will be appreciated that the electronic device 900 may be a telephone, an audio player, a camera, a PDA, a tool such as a multimeter, an oscilloscope, a game, a palmtop computer and so on in continual variation and combinations thereof including other electronic devices now known or later developed.

It will be seen that in this embodiment, the central device may only loosely be described as a “computer” (although it may incorporate therein a functional CPU), and may better be described as a telephone, tool, etc. Thus, it is seen that the invention is one which may work with electronic devices having operating systems, not just with computers.

This last point is important as the world of “operating systems” is expanding to include vehicles, appliances and a host of tools and informational and communicational devices and entertainment units of all types.

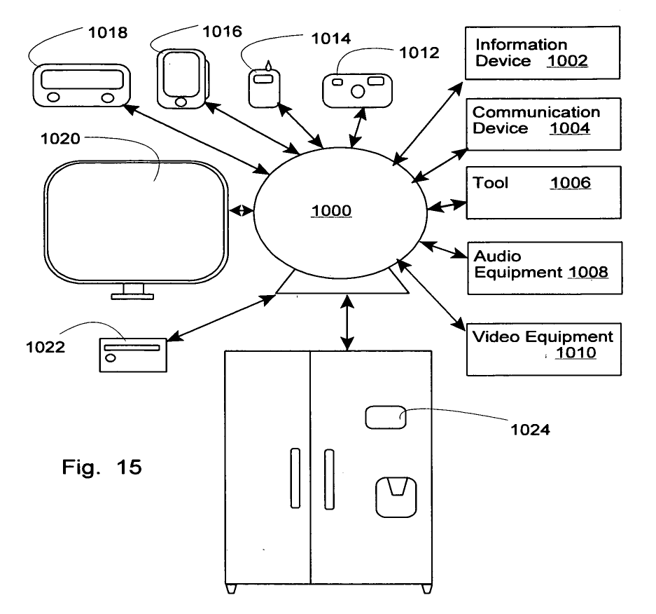

FIG. 15 is a block diagram of a sixth embodiment. Computer 1000 may be connected to a wide variety of different devices of different types. Information device 1002 may be a network such as the Internet, a server, a computer, an external mass storage device another computer or the like. Similarly communication device 1004 may be a network or the like, an RF receiver/transmitter, a modem and so on. Tool 1006 may be a hand tool having electronic systems therein (such as those used by telephone linemen), an oscilloscope or another scientific device, a larger tool such as a vehicle or power equipment, an automobile, an installation such as a manufacturing facility and so on. Audio equipment 1008 may be a mixing board, a recorder, an MP3 player or other audio player and the like. Video equipment 1010 may be a video device, a video player, a camera and so on. Camera 1012 may be considered a subset of video equipment 1010, and combination telephone/MP3 player 1014 may be considered either communication equipment or audio equipment. PDA 1016 and game 1018 are self explanatory.

It will be appreciated that computer peripherals 1020, 1022 are exemplary only, (for example a screen and printer) and all peripherals now known or later devised may be included within the definition. Similarly, appliance 1024 may be a refrigerator, but it may be any other common appliance such as a washer, dryer, stove, television and so on.

The embodiment of computer 1000 shown is a “portable” and “non-stand alone” version in which the computer may be considered to move from place to place in hand. The size of such an embodiment may advantageously be only a bit bigger than an actual random access optical disk drive, itself only a bit bigger than the optical disk within. The use of standard connectors as shown in the diagrams and discussed with reference thereto (USB ports, power ports, IEEE rated ports, standard peripheral ports such as parallel ports, minijacks and the like) enables the computer to function where ever another computer is already located or where peripherals may be found.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the claims of the invention: the scope of the invention is to be understood from the claims accompanying this disclosure.

1. An improved electronic device having an operating system, wherein the improvement comprises:
an optical mass storage device having thereon a boot sector, the optical mass storage device being addressable by such operating system as a bootable drive.

2. The improved electronic device of claim 1, wherein the optical mass storage device addressable by such operating system is further addressable as a hard drive.

3. The improved electronic device of claim 1, wherein the optical mass storage device is sealed.

4. The improved electronic device of claim 1, wherein the optical mass storage device is formatted so as to be randomly accessible.

5. The improved electronic device of claim 1, wherein the optical mass storage device is addressed by sector and track.

6. The improved electronic device of claim 1, wherein the optical mass storage device is fixedly mounted in the electronic device.

7. The improved electronic device of claim 1, wherein the improved electronic device further comprises one member selected from the group consisting of: information devices, communication devices, computer peripherals, games, appliances, tools, telephones, personal digital assistants, cameras, audio equipment, video equipment and combinations thereof.

8. The improved electronic device of claim 1, wherein the improved electronic device further comprises a computer.

9. The improved electronic device of claim 8, wherein the computer further comprises at least one standard electronic connector.

10. The improved electronic device of claim 8, wherein the computer further comprises at least one standard peripheral.

11. A mass storage device for use with a electronic device having an operating system, the mass storage device comprising:
a hard disk to operating system interface module operatively connected to such operating system and capable of interacting with such operating system as a hard drive by receiving hard drive specific commands from such operating system and by sending to such operating system hard drive specific information;
an interface to disk control module operatively connected to the hard disk to operating system module;
a compact disk controller operating the hardware of a sealed compact optical disk and operatively connected to the interface to disk control module;
the interface to disk control module capable of using hard drive specific commands received by the hard disk to operating system interface module to command the compact disk controller, and further capable of receiving information from the compact disk controller and providing therefrom hard drive specific information.

12. The mass storage device of claim 11, wherein the sealed compact optical disk is formatted so as to be randomly accessible.

13. The mass storage device of claim 11, wherein the sealed compact optical disk is addressed by sector and track.

14. The mass storage device of claim 11, wherein the optical mass storage device is fixedly mounted in the electronic device.

15. The mass storage device of claim 11, wherein such electronic device having an operating system further comprises one member selected from the group consisting of: computers, information devices, communication devices, computer peripherals, games, appliances, tools, telephones, personal digital assistants, cameras, audio equipment, video equipment and combinations thereof.

16. The mass storage device of claim 11, further comprising:
a plurality of actuator arms, each actuator arm having thereon at least one read/write head, the actuator arms located at different locations on the mass storage device.

17. The mass storage device of claim 16, wherein at least two actuator arms are located on different sides of the mass storage device.

18. The mass storage device of claim 11, wherein the interface to disk control module further comprises:
an analog to digital converter (A/D converter) capable of receiving analog format information and converting it to digital information.
